(19) United States
(12) Patent Application Publication
(10) Pub. No.: US 2016/0317249 A1
(43) Pub. Date: Nov. 3, 2016

(54) Assembled device for retrieving broken instrument from root canal

(71) Applicants: Jun Peng, Wuhan (CN); Chengdu Premier Medical Consulting Co.,Ltd., Chengdu (CN)

(72) Inventors: Yuan Gao, Chengdu (CN); Qian Yang, Chengdu (CN); Dingming Huang, Chengdu (CN); Xuedong Zhou, Chengdu (CN)

(73) Assignees: Chengdu Premier Medical Consulting Co.,Ltd.; Jun Peng

(21) Appl. No.: 15/208,485

(22) Filed: Jul. 12, 2016

(30) Foreign Application Priority Data
Aug. 28, 2015 (CN) 201510537471.0

(51) Int. Cl. A61C 5/02

(52) U.S. Cl. CPC A61C 5/026

(57) ABSTRACT

An assembled device for retrieving broken pieces from a root canal includes a hollow hand-held pole, a needle socket which connected to a needle cannula. An insert unit and an insert holder are inside the hollow hand-held pole. A sliding push button is outside the hollow hand-held pole which can move the insert unit up and down. The insert wedge extends to the needle cannula through the needle socket and move up and down a curved and beveled end of which engages the broken instrument and urge the broken instrument into the cutout so the device will mechanical grasp the broken instrument A cutout is spaced from the end of needle cannula. The present invention has a compact structure and stable performance. The vulnerable part can be replaced easily. It can work under the dental microscope and can also work as MTA carrier.

### CROSS REFERENCE OF RELATED APPLICATION

The application claims priority under 35 U.S.C. 119(a-d) to CN 201510537471.0, filed Aug. 28, 2015.

### BACKGROUND OF THE PRESENT INVENTION

1. Field of Invention

The present invention relates to a dental instrument field, and more particular to an assembled device for retrieving broken instrument from the root canal during endodontic procedure.

2. Description of Related Arts

The pulp or pulp chamber is the soft area within the center of the tooth. The tooth's nerve is in the root canals which in the root of the tooth. Root canal or endodontic treatment which done inside of the tooth is necessary when the pulp is inflamed or infected. The inflammation or infection may has a variety of causes: deep decay, repeated dental treatment on the tooth, faulty crowns, or a crack or chip in the tooth.

Conventionally, root canal treatment is the most effective way to treat the disease of pulp. The root canal treatment are performed towards the elimination of pulp, bacteria and other microorganisms from the root canal system by chemo-mechanical preparation, followed by three-dimensional obturation the canal space with an root canal filling material. The clinical procedure of root canal treatment comprises root canal preparation, root canal disinfection and root canal filling.

The quality of root canal preparation is one of the key factors which decide the success of root canal therapy. Root canal preparation is accomplished by utilizing various dental instruments, such as NiTi instrument, barbed broach, endodontic files and drills.

During the root canal preparation the aforementioned dental instruments may be broken and separated from the main part. This may bring tremendous trouble to the root canal therapy and compromises the prognosis of root canal treatment. Conventionally, the broken instrument will be preferably taken out before going on with the root canal treatment. Taking out the broken instrument is very time-consuming and pose formidable challenges, especially the instrument breaks around the curvature of root canal.

The conventional steps to take out the broken instrument include first using the trepan drill or ultrasonic tip to remove a tiny part of the dentin around the fragment of broken instrument to loosen the broken instrument; then using a device to retrieve the broken instrument. Some instrument retrieval techniques have been developed over the years. Tubes in varied size is at disposal for placing over the topmost coronal end of the broken instrument and different methods is able to be adopted to retrieve the broken instrument. The tubes have been attached to the broken instrument by various means such as glue, mechanical friction and etc. which engage the broken instrument.

Traditional system is proposed using a hollow tube in which a plunger with a beveled end is slid in order to engage the obstruction, or using a hollow tube in which an stretching pole with a tapered and rounded end in order to urge a top end of the instrument into the cutout, the shaft and tube cooperating to grasp the broken instrument. These instrument is very difficult to use and handle by hand because the space limitation of oral cavity. Moreover, constricted by the design, the hollow tube is thin and the cutout window is quite close to the end of the tube, so the device is vulnerable and cannot be used for long time. This limitation makes these systems costly.

Dental operating microscopes are critically essential for safe and successful broken instrument removal. The conventional device for retrieving the broken instrument is impossible to ensure the hollow tube slide down the canal and over the exposed broken instrument directly under the microscope because of the obstruction of the handle, and such device is not able to work well under microscope because the lack of a manual handle to hold; Additionally, attempting to remove a broken instrument may lead to serious iatrogenic events, such as perforation of the root, which can alter prognosis. So it also need use the device of carrier to repair the perforation with biocompatible biomaterials such as MTA.

Therefore, an ergonomic design for an assembled device with simple structure and replaceable vulnerable parts for retrieve the broken instrument which is able to work under the microscope is needed. It is preferable that when the perforation occurring in the retrieve process, the assemble device is also able to be used as a biomaterials carrier such as MTA.

### SUMMARY OF THE PRESENT INVENTION

The present invention provides an assembled device for taking out broken pieces in a root canal which overcome the disadvantages of the conventional device. The device has a compact structure which is easy to use and very stable,

In order to achieve the above mentioned object, the present invention adopts the following technical solutions:

An assembled device for taking out broken pieces from a root canal comprises: a hollow hand-held pole, a needle socket screw-thread fit the hollow hand-held pole at the bottom, a needle cannula on a needle socket, a oval side window at the end of the needle cannula. The protecting cap fixes the needle cannula on the needle socket and the needle cannula is able to extend to the root canal meanwhile the top of the broken instrument extends to the needle cannula

An insert unit is inside the hollow hand-held pole which comprises an insert socket and insert set. The insert comprises a fix end and a curved beveled end. The fix end is connected to the insert socket. The insert extends to the needle cannula through the needle socket. The size of the insert matches with the needle cannula and the inset can move inside the needle cannula.

Outside the hollow hand-held pole there is a sliding push button which is connected to the insert unit by a limiting bolt. The sliding push button moves the insert unit up and down inside the needle cannula along the axis length. The curved and beveled end of the insert is opposite to the oval window. The curved beveled end guides the top of broken instrument slid out of the oval window while gripping and retrieve the broken piece.

A pushing pole screw-thread fit the hand-held pole at its upper part. A rotating handle is at the top of the pushing pole which can push the insert unit move forward. When the broken pieces is clamped tight between the teeth and greater strength is needed rotates the rotating handle at the top of the pushing pole and push the insert unit to press the broken pieces to the lower end of the oval window so that the broken piece is able to be taken out steadily.

The present invention has the advantages as follows.

1. The present invention has a simple structure and is easy to use. After being used for several times, the needle cannula are fatigue and damaged that can no longer be used. The damaged needle cannula can be dissembled from the main body. There is no need to change the whole device. Similarly, all parts can be replaced if damaged, which is cost-saving. The slide block can be easily moved in the axial direction, which is ergonomics and reasonable. The needle can be bent by a pre-bending device in order to work under microscope. The needle cannula and the insert wedge can be replaced with a needle unit which carry MTA so that the device can be used for other purposes.

2. When the broken instrument is struck in the root canal of the teeth, higher gripping strength is needed. Simply relying on the sliding push button is difficult to retrieve the broken instrument. Much effort is needed and the device is not steady. In this situation, the rotating handle on the top end of the pushing pole needs to be rotated for pushing the pushing pole against the insert unit. The insert will compress and grip the broken instrument with the side oval window of the needle cannula. The pushing pole makes the device more stable to operate

3. A side oval window is at the working end of the needle cannula. A curved and beveled surface at the end of the insert wedge is set opposite to the oval window. The curved and beveled surface guides the broken instrument through the oval window that makes the broken instrument pressed more tightly in the needle cannula. The design will secure a higher success rate for griping the broken instrument.

4. The press threaded hole extended out of the hollow hand-held pole and is closed to the bottom end of the hollow hand-held pole. The structure enables the disassembly of the insert wedge without taking out the whole insert unit by taking out the press bolt, which improves the efficiency and saves much effort.

### BRIEF DESCRIPTION OF THE DRAWINGS

FIG. 1 is a structure diagram of the present invention without using a pushing pole;

FIG. 2 is a structure diagram of the present invention while using the pushing pole;

FIG. 3 is a structure diagram of the present invention without a cover cap;

FIG. 4 is a structure diagram of the pushing pole;

FIG. 5 is a structure diagram of a hollow hand-held pole;

FIG. 6 is a structure diagram of an insert unit;

FIG. 7 is a structure diagram of a needle socket;

FIG. 8 is a structure diagram of a needle cannula with side oval window;

FIG. 9 is a structure diagram of the present invention of the insert wedge gripping the broken instrument within the curved needle cannula in the tooth.

FIG. 10 is a partial structure diagram of the present invention showing the use of the insert wedge and needle cannula to grasp the broken instrument for removal of the obstruction from the root canal.

FIG. 11. illustrate a curved needle installed on the needle socket

### REFERENCE NUMERALS

1—needle cannula; 1-1—cannula, 1-1.1—oval window, 1-2—connector, 2—needle socket, 3—insert unit, 3-1—insert wedge, 3-1.1—curved and beveled surface end, 3-1.2—fixed end, 3-2—insert holder, 3-2.1—press threaded hole, 3-2.2—limiting threaded hole, 3-2.3—insert hole, 3-3—press bolt, 4—sliding push button, 4-1—limiting bolt, 5—hollow hand-held pole, 5-2—bar limiting hole, 6—pushing pole, 6-1—rotating handle, 7—protecting cap, 8—top end of the device, 9—bottom end of the device.

### DETAILED DESCRIPTION OF DETAILED DESCRIPTION OF THE PREFERRED EMBODIMENT

The present invention is further explained with the accompanying drawings and embodiments as follows.

### Embodiment 1

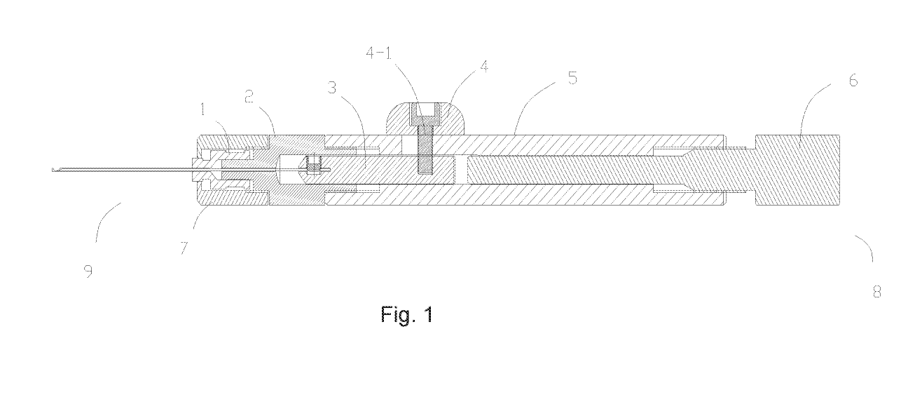

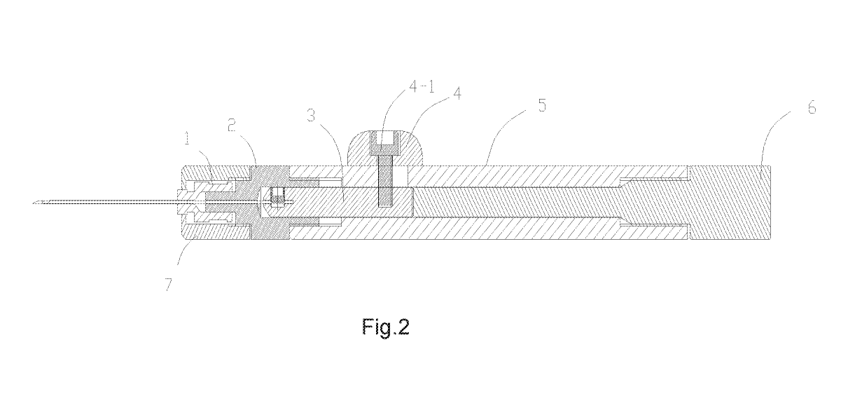

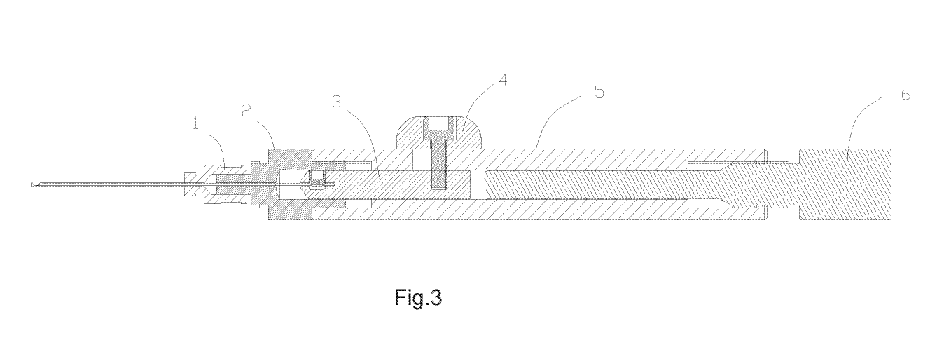

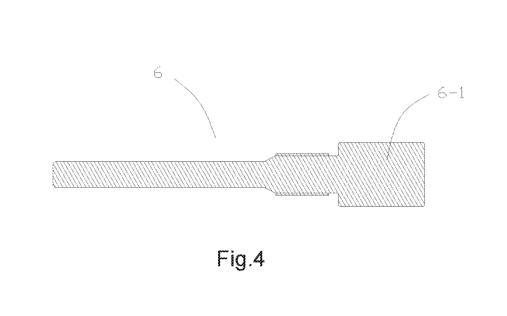

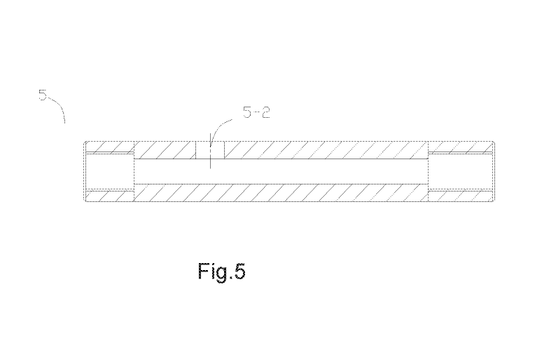

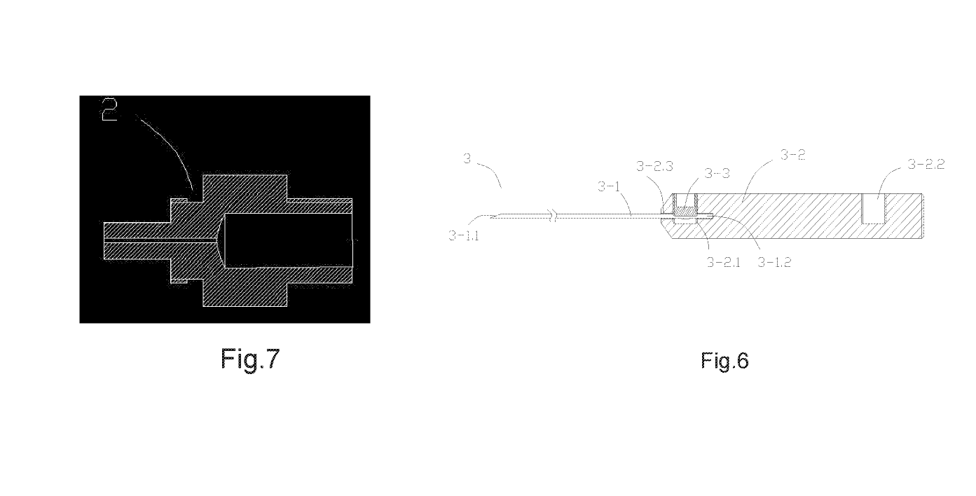

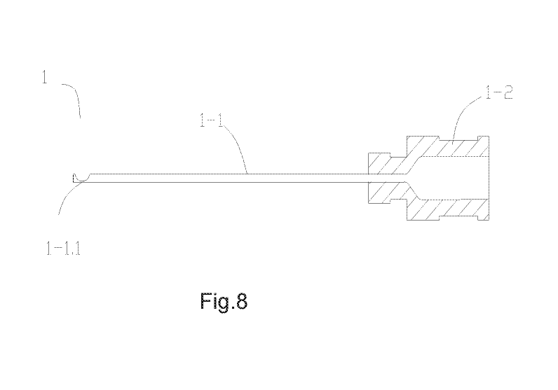

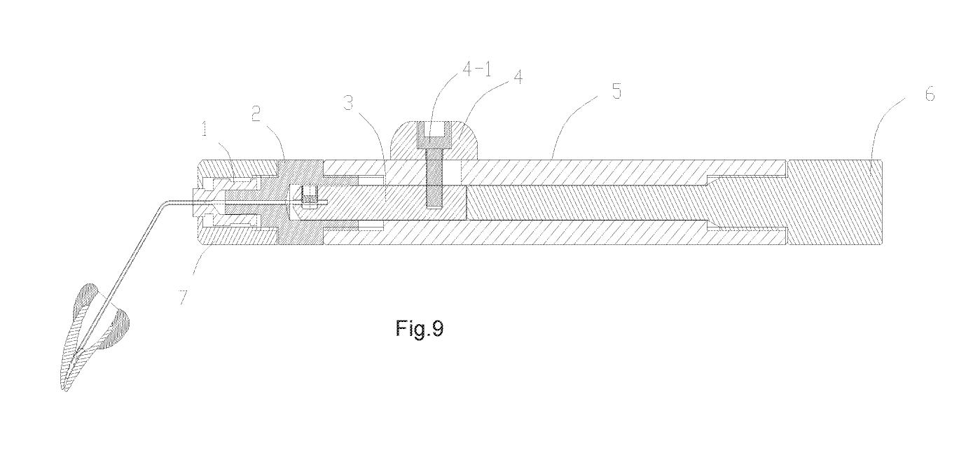

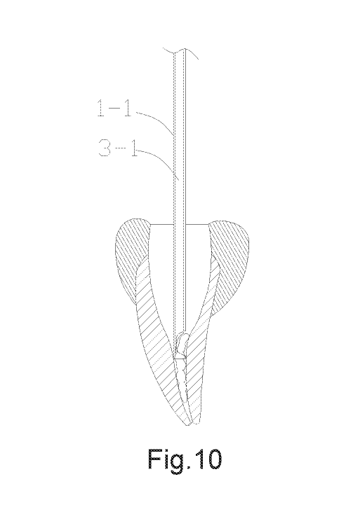

Referring to FIG. 1 to FIG. 10 of the drawings, according to the embodiment 1 of the present invention is illustrated, comprising a hollow hand-held pole 5, a needle socket 2 at the bottom of the hollow hand-held pole 5 and screw-thread fit the hollow hand-held pole 5, a needle cannula 1 on the needle socket 2, a insert unit 3 inside the hollow hand-held pole 5 and outside the aforementioned hollow hand-held pole 5 a slide block 4 moving the insert unit 3 up and down; wherein the insert unit 3 comprises insert holder 3-2 which is inside the hollow hand-held pole 5, insert wedge 3-1 which is fixed on the insert holder 3-2; the insert 3-1 extends to the needle cannula 1 through needle socket; The insert wedge 3-1 can move up and down inside the cannula 1. The needle socket 2 and needle cannula can be dissembled from the device.

In the embodiment 1, the slide block 4 on the hollow hand-held pole 5 drives insert unit 3 to move back and forth within the axial length of the bar limiting hole 5-2, which will make the insert 3-1 move back and forth inside the needle cannula. At one end of the needle cannula far away from the needle socket there is an oval window which opposites to the curved and beveled end of the insert. The oval window and the curved and beveled end works together to grip the broken instrument in the tooth. The curved and beveled end guide the broken instrument through of the oval window. After being used for several times the needle cannula 1 are fatigue and damaged that can no longer be used. The damaged needle cannula can be replaced. No need to change the whole device. Similar for other parts of the device, all parts can be replaced if damaged. The design is cost-saving.

### Embodiment 2

Referring to FIG. 1 to FIG. 10 of the drawings, according to the embodiment 2 of the present invention is illustrated, comprising a hollow hand-held pole 5

a needle socket 2 at the bottom of the hollow hand-held pole 5, a needle cannula 1 on the needle socket 2, a insert unit 3 inside the hollow hand-held pole 5 and outside the aforementioned hollow hand-held pole 5 a slide block 4 moving the insert unit 3 up and down; wherein the insert unit 3 comprises insert holder 3-2 which is inside the hollow hand-held pole 5, insert wedge 3-1 which is fixed on the insert holder 3-2; the insert 3-1 extends to the needle cannula 1 through needle socket; The insert wedge 3-1 can move up and down inside the cannula 1.

A pushing pole 6 inside the hollow hand-held pole 5 can be draw out form the top end of hollow hand-held pole 5, at a top end of the pushing pole 6 is the knurled rotating handle 6-1

An oval window 1-1.1 is at an end of needle cannula 1; The insert wedge 3-1 comprises a fixed end 3-1.2 and a curved and beveled surface end 3-1.1; The curved and beveled end guide the top of the broken instrument through the oval window of the needle cannula for a better grip. The curved and beveled end is able to easily direct the broken instrument and prevent it from being pushed out of the apical portion of the root canal.

A bar limiting hole 5-2 is on the hollow hand-held pole 5; A limiting threaded hole 3-2.2 is on the insert holder 3-2; A limiting bolt 4-1 is on the slide block 4; the limiting bolt 4-1 matches the limiting threaded hole 3-2.2 through the bar limiting hole 5-2; The limiting bolt 4-1 matches the clearance and fit with the bar limiting hole 5-2; The clearance between the bar limiting hole and limiting bolt is 2˜6 mm in axial direction.

In the embodiment 2, when the broken instrument is stuck between the tooth higher gripping strength is needed. Simply rely on the sliding push button (4) is difficult to retrieve the broken instrument. Much effort is needed and the device can not perform steady. In this situation the rotating handle on the top end of the pushing pole is needed. Rotate the rotating handle (6-1) to push the pushing pole (6) against the insert unit (3). The insert wedge will compress and grip the broken instrument. The pushing pole (6) makes the device operate more stable. The needle cannula (1) and the insert wedge (3) can be replaced with the needle cannula without side oval window and insert plunger with flat end which carry repair biomaterials (such as MTA) so that the device can be used for another purpose.

### Embodiment 3

Referring to FIG. 1 to FIG. 10 of the drawings, according to a embodiment 3 of the present invention is illustrated, comprising a hollow hand-held pole 5 a needle socket 2 at the bottom of the hollow hand-held pole 5, a needle cannula 1 on the needle socket 2, a insert unit 3 inside the hollow hand-held pole 5 and outside the aforementioned hollow hand-held pole 5 a slide block 4 moving the insert unit 3 up and down; wherein the insert unit 3 comprising insert holder 3-2 which is inside the hollow hand-held pole 5, insert wedge 3-1 which is fixed on the insert holder 3-2; the insert wedge 3-1 extends to the needle cannula 1 through needle socket; The insert wedge 3-1 can move up and down inside the cannula 1. The needle socket 2 and needle cannula 1 can be dissembled from the device.

A insert hole 3-2.3 is at the center of a bottom end of the insert holder 3-2 in axial direction; a press threaded hole 3-2.1 is on the insert holder 3-2 in radial direction; a press bolt 3-3 is inside the press threaded hole 3-2.1; the fixed end 3-1.2 of the insert 3-1 put through the insert hole 3-2.3 and fastened by the press bolt 3-3; This structure is feasible to produce, assemble and dissemble, which is very practical. The internal thread of the press threaded hole (3-2.1) matches the external thread of press bolt. The press bolt 3-3 is slotted. The press bolt is able to be fastened or taking out by using a straight screwdriver pointing to the slotted head and rotating.

### Embodiment 4

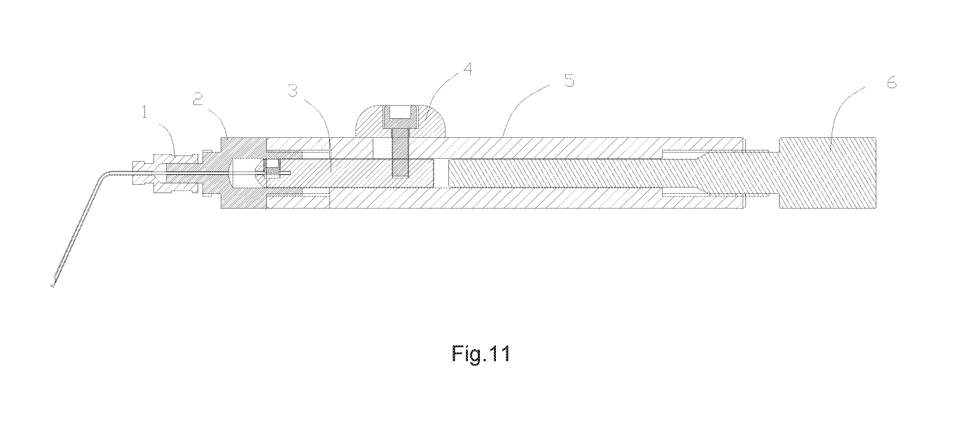

Referring to FIG. 1 to FIG. 11 of the drawings, embodiment 4 is the modification based on embodiment 1, 2 and 3.

The hollow handheld pole 5 connected to the needle socket through screw-thread fit; the hollow hand-held pole 5 connected to the pushing pole 6 through screw-thread fit; Inside the upper part of the hollow hand-held pole 5 there is internal thread which matches the external thread on the pushing pole 6. The internal thread on the hollow hand-held pole is longer than the external thread on the pushing pole 6, which ensure a better stability, accuracy and tightening torque. The pushing pole 6 and insert unit 3 match and work together. The screw-thread fit is feasible to produce, assemble and dissemble.

The needle cannula 1 comprises a cannula 1-1 and a connector 1-2; the needle socket 2 comprises a protecting cap 7 for preventing the connector 1-2 from getting loose. The protecting cap can make the device looks neat and prevent the needle cannula from loose and slip away. The needle cannula 1-1 matches the insert 3-1 diameter. The needle cannula 1-1 in various diameters is available to match the insert. The insert unit and needle cannula in various diameters can be chosen to match the diameter of the broken piece.

On both top and bottom sides of the slide block 4 symmetrically set two positioning plates 5-4 to prevent the slide block from slipping and ensure a better hold under the microscope.

The bottom end of insert holder 3-2 extends out of the hollow hand-held pole 5. The press threaded hole 3-2.1 is out of the hollow hand-held pole 5 and closed to the bottom end of the hollow hand-held pole. The structure enables the disassembly of the insert wedge 3-1 without taking out the whole insert unit 3 by taking out the press bolt 3-3 inside the press threaded hole 3-2.1, which improves the efficiency and saves much effort.

The insert wedge 3-1 is able to extend out of the bottom end of the needle cannula. The insert wedge 3-1 and the cannula 1-1 of the needle cannula 1 is able to be bent into different curves, which is convenient for operating under the dental microscope according to the different position of the tooth.

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. An assembled device for retrieving broken instrument from root canal, comprising: a hollow hand-held pole (5), a needle socket (2) at a bottom of the hollow hand-held pole (5), a needle cannula (1) on the needle socket (2), an insert unit (3) inside the hollow hand-held pole (5) and a sliding push button (4) outside the hollow hand-held pole (5) for moving the insert unit (3) up and down; wherein the insert unit (3) comprises an insert holder (3-2) which is inside the hollow hand-held pole and an insert wedge(3-1) which is fixed on the insert holder (3-2); wherein the insert wedge(3-1) extends to the needle cannula (1) through the needle socket.

2. The assembled device, as recited in claim 1, wherein the needle socket (2) and the needle cannula (1) are detachable.

3. The assembled device, as recited in claim 1, wherein the needle cannula (1) comprises a cannula (1-1) and a connector (1-2); the needle socket (2) comprises a protecting cap (7) for preventing the connector (1-2) from getting loose.

4. The assembled device, as recited in claim 1, wherein a pushing pole(6) inside the hollow hand-held pole(5)s drawn out form a top end of the hollow hand-held pole(5); at a top end of the pushing pole is the rotating handle(6-1).

5. The assembled device, as recited in claim 1, wherein a side oval window (1-1.1) is at an end of the needle cannula (1); the insert wedge (3-1) comprises a fixed end (3-1.2) and a curved and beveled end (3-1.1).

6. The assembled device, as recited in claim 1, wherein a bar limiting hole (5-2) is on the hollow hand-held pole (5); a limiting threaded hole (3-2.2) is on the insert holder (3-2); a limiting bolt (4-1) is on the sliding push button (4); the limiting bolt (4-1) matches the limiting threaded hole (3-2.2) through the bar limiting hole (5-2); the limiting bolt (4-1) matches fits in the bar limiting hole (5-2) with a clearance.

7. The assembled device, as recited in claim 1, wherein an insert hole (3-2.3) is at a center of the bottom end of the insert holder (3-2) in an axial direction; a press threaded hole (3-2.1) is on the insert holder (3-2) in a radial direction; a press bolt (3-3) is inside the press threaded hole (3-2.1); a fixed end (3-1.2) of the insert wedge (3-1) is put through the insert hole (3-2.3) and is fastened by the press bolt (3-3).

8. The assembled device, as recited in claim 7, wherein the insert holder (3-2) extends out of the hollow hand-held pole (5) and the press threaded hole (3-2.1) is close to the bottom end of the hollow hand-held pole (5).

9. The assembled device, as recited in claim 4, wherein the hollow hand-held pole (5) connected to the needle socket (2) through screw-thread fit; the hollow hand-held pole (5) connected to the pushing pole (6) through screw-thread fit; the pushing pole (6) and the insert unit (3) cooperate with each other.

10. The assembled device, as recited in claim 1, wherein the insert wedge (3-1) is long enough to extend out of the bottom end of the needle cannula (1).
